(19) United States
(12) Patent Application Publication
(10) Pub. No.: US 2006/0083188 A1
(43) Pub. Date: Apr. 20, 2006

(54) Synchronous ethernet network and time allocation method used therein

(75) Inventors: Seo-Won Kwon, Seoul (KR); Jae-Yeon Song, Seoul (KR); Se-Youn Lim, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/129,951

(22) Filed: May 16, 2005

(30) Foreign Application Priority Data
Oct. 15, 2004 (KR) 2004-82616

(51) Int. Cl. H04Q 7/00

(52) U.S. Cl. 370/314

(57) ABSTRACT

Disclosed are a synchronous Ethernet network and a time allocation method used therein. The synchronous Ethernet network includes a gateway having a plurality of ports, and a plurality of network points having one-to-one connection with the ports of the gateway in a star topology, the gateway allocating time to the network end points based on a cycle including an asynchronous part and a synchronous part, wherein the gateway prepares a plurality of time slots by dividing the synchronous part in one cycle according to ports and allocates at least one divided time slot to each network end-point participating in communication in a corresponding cycle.

### CLAIM OF PRIORITY

This application claims priority to an application entitled “Synchronous Ethernet Network and Time Allocation Method Used Therein,” filed in the Korean Intellectual Property Office on Oct. 15, 2004 and assigned Serial No. 2004-82616, the contents of which are incorporated herein by reference.

### BACKGROUND OF THE INVENTION

1. Field of the Invention

The present invention relates to synchronous Ethernet, and more particularly to a synchronous Ethernet network and a time allocation method used in the synchronous Ethernet network.

2. Description of the Related Art

Synchronous Ethernet is one of many techniques utilized to transmit real-time data, such as voice/video data. The synchronous Ethernet is typically connected to an external network to service a specific residential area and includes a gateway and stations (network end points connected to the gateway). Current synchronous Ethernet network allocates transmission of signals based on a time cycle including an asynchronous part and a synchronous part. A medium access control (MAC) layer standard is only industry standard that have been defined for the synchronous Ethernet network, where each cycle corresponds to 125 μs between the stations.

FIG. 1 shows a time allocation table 100 according a typical synchronous Ethernet network. As shown in FIG. 1, one cycle 110 in the time allocation table 100 includes an asynchronous (ASYNC) part 120 and a synchronous (SYNC) part 130, and their cycle has a bandwidth of 125 μs. Herein, asynchronous data are transmitted in the asynchronous part 120, and synchronous data such as real time data are transmitted in the synchronous part 130.

However, in the above-described synchronous Ethernet network, data are processed according to the cycles. Further, synchronous data transmitted by a station in a specific cycle is stored in a buffer register of a gateway before being transmitted to a destination station in a next cycle. As a result, at least one cycle transmission delay of real time data occurs.

### SUMMARY OF THE INVENTION

Accordingly, the present invention has been made to solve the above-mentioned problems occurring in the prior art and provides additional advantages, by providing a synchronous Ethernet network and a time allocation method used in the synchronous Ethernet network capable of minimizing a transmission delay of synchronous data.

In one embodiment, there is provided a synchronous Ethernet network including a gateway having a plurality of ports, and a plurality of network points having one-to-one connection with the ports of the gateway in a star topology, wherein the gateway allocates time to the network end-points based on a cycle including an asynchronous part and a synchronous part. The gateway prepares a plurality of time slots by dividing the synchronous part in one cycle according to the number of ports and allocates at least one divided time slot to each network end-point communicating in a corresponding cycle.

In another embodiment, there is provided a time allocation method for a synchronous Ethernet network including a gateway and a plurality of network end points, the gateway allocating time based on a cycle including an asynchronous part and a synchronous part, the network end points connected to the gateway. The method includes the following steps of (a) preparing a plurality of time slots by multi-dividing the synchronous part in one cycle, and (b) allocating at least one divided time slot to each network end-point participating in communicating in a corresponding cycle.

### BRIEF DESCRIPTION OF THE DRAWINGS

The above and other features and advantages of the present invention will be more apparent from the following detailed description taken in conjunction with the accompanying drawings, in which:

FIG. 1 is a view showing a time allocation table of a typical synchronous Ethernet network;

FIG. 2 is a view showing a structure of a synchronous Ethernet network according to a preferred embodiment of the present invention;

FIG. 3 is a view for explaining a method for allocating time in a synchronous Ethernet network according to a first embodiment of the present invention;

FIG. 4 is a view for explaining a method for allocating time in a synchronous Ethernet network according to a second embodiment of the present invention; and

FIG. 5 is a view for explaining a method for allocating time in a synchronous Ethernet network according to a third embodiment of the present invention.

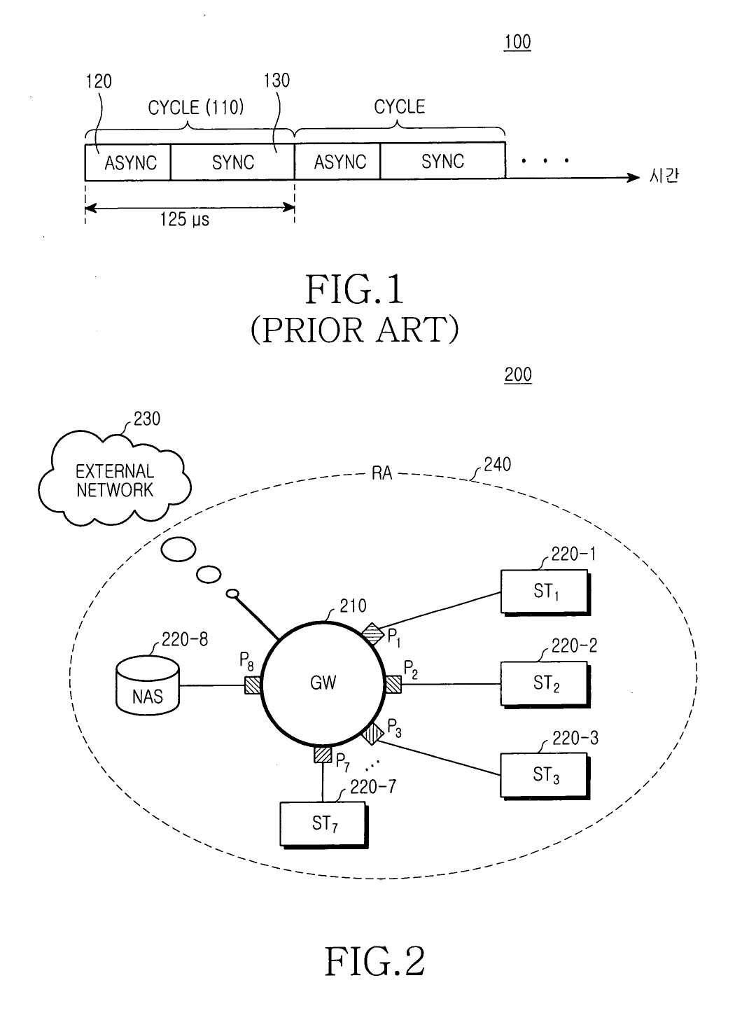

### DETAILED DESCRIPTION

Hereinafter, embodiments of the present invention will be described in detail with reference to the accompanying drawings. Note that the same or similar components in drawings are designated by the same reference numerals as far as possible although they are shown in different drawings. For the purposes of clarity and simplicity, a detailed description of known functions and configurations incorporated herein will be omitted as it may make the subject matter of the present invention unclear.

FIG. 2 is a view showing a structure of a synchronous Ethernet network 200 according to a preferred embodiment of the present invention. As shown, the synchronous Ethernet network 200 is connected to an external network 230 such as Internet and includes a gateway (GW) 210, a first station (ST) to a seventh station (ST) 220-1 to 220-7, and a network attached storage 220-8. Herein, the synchronous Ethernet network 200 covers one residential area (RA) such as an office or a home, and each station refers to an apparatus (personal computer, etc.) in a client side. Although a limited number of STAs is shown in FIG. 2 for illustrative purposes, it is to be understood that the inventive network can support concurrent communications between a much larger number of STAs. Thus, the number of STAs in the drawing should not impose limitations on the scope of the invention.

The gateway 210 is connected to the external network 230 and includes a first port (P) to an eighth port (P). The gateway 210 may include a buffer register for storing the received synchronous data and an Ethernet switch for switching and transmitting the synchronous data stored in the buffer register into and to a destination station. Note that teachings of the present invention may be applied to a network having a larger number of ports than the number of ports shown in FIG. 2. The first station to the seventh station 220-1 to 220-7 represent network end points, and each station is in communication with another station as well as with the external network 230 through the gateway 210, or the network attached storage 220-8.

The network attached storage 220-8, which is a network end-point, is connected to the eighth port of the gateway 210 and stores real time data such as voice/video data and transmits stored real time data to a corresponding station during a synchronized state. The first station to the seventh station 220-1 to 220-7 and the network attached storage 220-8 have one-to-one connection with the first port to the eighth port of the gateway 210 in a star topology.

Now, a method for allocating time in the synchronous Ethernet network 200 will be described.

The gateway 210 is temporally synchronized with the network end points 220-1 to 220-8. The gateway 210 serves as a time master of the entire network 200. Accordingly, the gateway 210 allocates time to the network attached storage 220-8 and the first station to the seventh station 220-1 to 220-7 based on cycles consist of asynchronous parts and synchronous parts. Asynchronous data are transmitted in the asynchronous part and synchronous data are transmitted in the synchronous part. One cycle has a bandwidth of 125 μs.

More specifically, the gateway 210 performs the following two steps:

(a) A synchronous part in one cycle is divided into eight slots corresponding to the number of ports, thereby preparing a first time slot (TS) to an eighth time slot (TS) in the synchronous part. Herein, each time slot (a bandwidth of the synchronous part/the number of ports) has a bandwidth of t; and

(b) At least one divided time slot is allocated to each of network end-points participating in communication in a corresponding cycle. Each network end-point can transmit synchronous data only at a time slot allocated to the network end-point.

Further, the gateway 210 processes synchronous data received with a period of t in the synchronous part. That is, the gateway 210 stores synchronous data transmitted from a given network end-point at a time slot in the buffer register and then transmits the synchronous data to a destination station during a next time slot, so that transmission delay of real time data is minimized. Network end-points participating in communication during the corresponding cycle transmit synchronous data without overlapping on a time axis. Therefore, after successively receiving the synchronous data, the gateway 210 transmits synchronous data sequentially stored in the buffer register to destination stations in a sequential order.

Hereinafter, the method of allocating time in the synchronous Ethernet network 200 according to the present invention may be realized as a first embodiment, a second embodiment, or a third embodiment, which will be described below, according to the way in which time slots are allocated in step (b) described above.

Table 1 shows synchronous data transmitted in the synchronous Ethernet network 200. For example, in a first synchronous data D1, the first station 220-1 corresponds to a source, and a second station 220-2 corresponds to a destination.

TABLE 1

| data | source | destination |
|---|---|---|
| D₁ | ST₁ | ST₂ |
| D₂; D₃ | ST₂ | ST₁; ST₃ |
| D₄; D₅; D₆ | ST₃ | ST₁; ST₂; ST₄ |
| D₇; D₈ | NAS | ST₁; ST₃ |

### THE FIRST EMBODIMENT

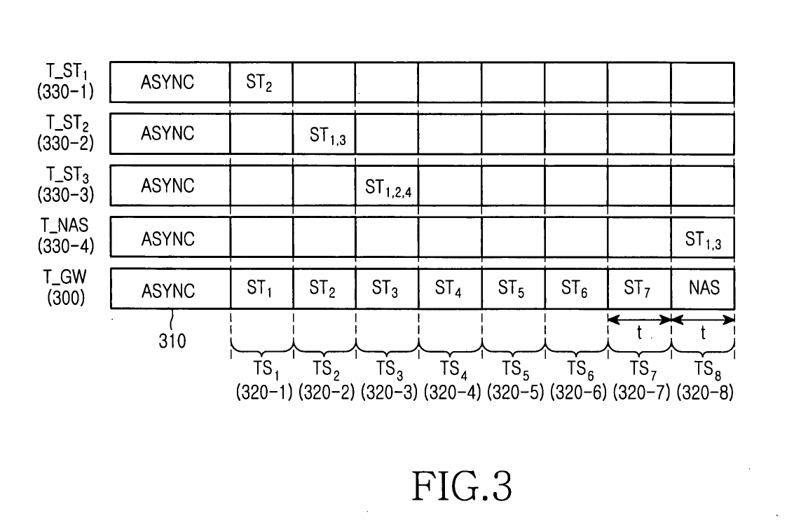

FIG. 3 is a view for explaining a method for allocating time in the synchronous Ethernet network 200 according to the first embodiment of the present invention. The figure shows a time allocation table (T_GW) 300 of the synchronous Ethernet network 200, a transmission table (T_NAS) 330-4 of the network attached-storage 220-8, and transmission tables (T_STs) 330-1 to 330-3 of the first station to the third station 220-1 to 220-3. In other words, FIG. 3 shows only the network end points of table 1 participating in data transmission. Herein, each transmission table represents destinations of synchronous data transmitted by a corresponding station.

The method of allocating time in the synchronous Ethernet network 200 according to the first embodiment of the present invention includes the two following steps:

(a-1) A synchronous part is divided into eight slots corresponding to the number of ports in one cycle including a synchronous part and an asynchronous part 310, thereby preparing a first time slot (TS) to an eighth time slot (TS) 320-1 to 320-8. Herein, each time slot (a bandwidth of the synchronous part/the number of ports) has a bandwidth of t; and

(b-1) One divided time slot is allocated to each of the network attached storage 220-8 and the first station to the seventh station 220-1 to 220-7. That is, the eighth time slot 320-8 is allocated to the network attached storage 220-8, and the m^{th} time slot 320-m is allocated to the m^{th} station 220-m. Herein, m is an integer below 7.

The first station 220-1 transmits first synchronous data at the first time slot 320-1, the second station 220-2 transmits second synchronous data and third synchronous data at the second time slot 320-2, the third station 220-3 transmits fourth synchronous data and sixth synchronous data at the third time slot 320-3, and the network attached storage 220-8 transmits seventh synchronous data and eighth synchronous data at the eighth time slot 320-8.

At this time, when the bandwidth of synchronous data, which must be transmitted at a certain time slot, exceeds the bandwidth of the time slot, the exceeded synchronous data are transmitted at a time slot in a next cycle. For example, if the second synchronous data and the third synchronous data, which have to be transmitted by the second station 220-2, have bandwidths equal to the bandwidth of the second time slot 320-2, the second station 220-2 transmits the second synchronous data at the second time slot 320-2 in a current cycle and the remaining third synchronous data at a second time slot in a next cycle.

### THE SECOND EMBODIMENT

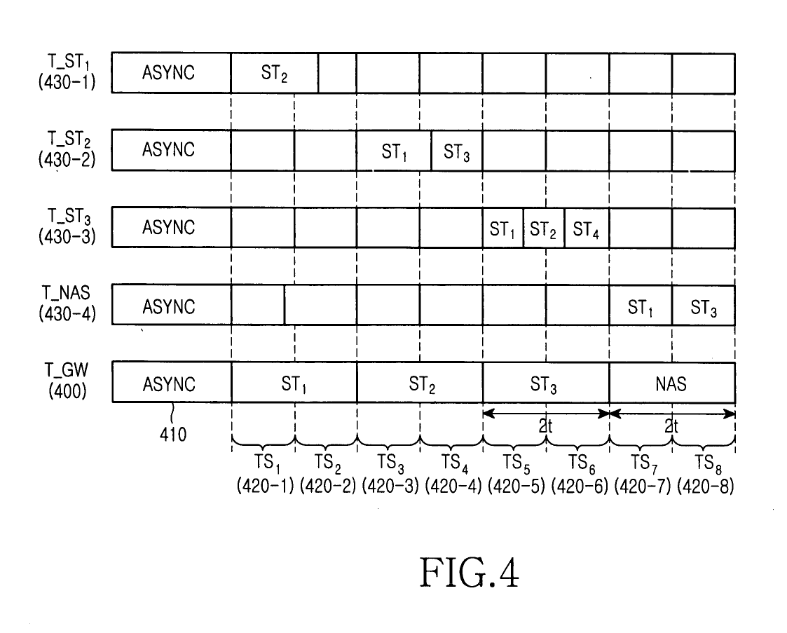

FIG. 4 is a view for explaining a method for allocating time in the synchronous Ethernet network according to the second embodiment of the present invention. The figure shows a time allocation table 400 of the synchronous Ethernet network 200, a transmission table 430-4 of the network attached storage 220-8, and transmission tables 430-1 to 430-3 of the first station to the third station 220-1 to 220-3.

The method of allocating time in the synchronous Ethernet network 200 according to the second embodiment of the present invention includes the two following steps:

(a-2) A synchronous part is divided into eight slots corresponding to the number of ports in one cycle including a synchronous part and an asynchronous part 410, thereby preparing a first time slot (TS) to an eighth time slot (TS) 420-1 to 420-8 in the synchronous part; and

(b-2) The divided time slots are equally allocated to source network end points participating in communication in a corresponding cycle. Referring to table 1, since the number of the source network end points participating in communication in a corresponding cycle is 4, each network end point is allocated time slots having a bandwidth of 2t μs. In other words, the first station 220-1 is allocated the first time slot and the second time slot 420-1 and 420-2, the second station 220-2 is allocated the third time slot and the fourth time slot 420-3 and 420-4, the third station 220-3 is allocated the fifth time slot and the sixth time slot 420-5 and 420-6, and the network attached storage 220-8 is allocated the seventh time slot and the eighth time slot 420-7 and 420-8.

The first station 220-1 transmits first synchronous data at the first time slot and the second time slot 420-1 and 420-2, the second station 220-2 transmits second synchronous data and third synchronous data at the third time slot and the fourth time slot 420-3 and 420-4, the third station 220-3 transmits fourth synchronous data to sixth synchronous data at the fifth time slot and the sixth time slot 420-5 and 420-6, and the network attached storage 220-8 transmits the seventh synchronous data and the eighth synchronous data at the seventh time slot and the eighth time slot 420-7 and 420-8.

### THE THIRD EMBODIMENT

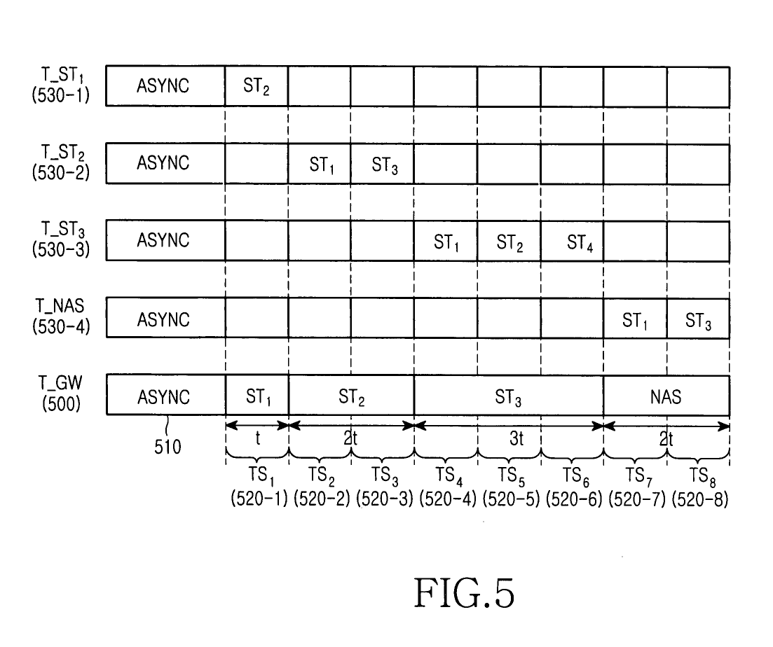

FIG. 5 is a view for explaining a method for allocating time in the synchronous Ethernet network according to the third embodiment of the present invention. The figure shows a time allocation table 500 of the synchronous Ethernet network 200, a transmission table 530-4 of the network attached storage 220-8, and transmission tables 530-1 to 530-3 of the first station to the third station 220-1 to 220-3.

The method of allocating time in the synchronous Ethernet network 200 according to the third embodiment of the present invention includes the two following steps:

(a-3) A synchronous part is divided into eight slots corresponding to the number of ports in one cycle including a synchronous part and an asynchronous part 510, thereby preparing a first time slot (TS) to an eighth time slot (TS) 520-1 to 520-8 in the synchronous part; and

(b-3) The divided time slots are allocated to each of network end points participating in communication in a corresponding cycle in proportion to the number of destinations corresponding to each network end-point. Referring to table 1, the first station 220-1 participating in communication in a corresponding cycle has one destination, the second station 220-2 has two destinations, the third station 220-3 has three destinations, and the network attached storage 220-8 has two destinations. In other words, the first station 220-1 is allocated the first time slot 520-1, the second station 220-2 is allocated the second time slot and the third time slot 520-2 and 520-3, the third station 220-3 is allocated the fourth time slot to the sixth time slot 520-4 to 520-6, and the network attached storage 220-8 is allocated the seventh time slot and the eighth time slot 520-7 and 520-8.

The first station 220-1 transmits the first data at the first time slot 520-1, the second station 220-2 transmits the second data and the third data at the second time slot and the third time slot 520-2 and 520-3, the third station 220-3 transmits the fourth data to the sixth data at the fourth time slot to the sixth time slot 520-4 to 520-6, and the network attached storage 220-8 transmits the seventh data and the eighth data at the seventh time slot and the eighth time slot 520-7 and 520-8.

As described above, the synchronous Ethernet network and a method for allocating time therein according to the present invention divide a synchronous part in one cycle by the number of gateway ports so as to allocate the divided synchronous part to network end points. In addition, the synchronous Ethernet network and the method for allocating time therein process synchronous data received with the period of t (a bandwidth of a time slot), that is, stores synchronous data received from a certain network end point at a certain time slot in a buffer register and then transmits the synchronous data to a destination station at a next time slot. Therefore, it is possible to minimize transmission delay of real time data.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A synchronous Ethernet network comprising:
a gateway which includes a plurality of ports; and
a plurality of network points having one-to-one connection with the ports of the gateway in a star topology, the gateway allocating time to the network end-points based on a cycle including an asynchronous part and a synchronous part, wherein the gateway prepares a plurality of time slots by dividing the synchronous part in one cycle according to the ports and allocates at least one divided time slot to each network end-point participating in communication during a corresponding cycle.

2. The synchronous Ethernet network as claimed in claim 1, wherein the network end points include at least one network attached storage and a plurality of stations, the network attached storage storing real time data.

3. A time allocation method for a synchronous Ethernet network including a gateway and a plurality of network end points, the gateway allocating time based on a cycle including an asynchronous part and a synchronous part, the network end-points connected to the gateway, the time allocation method comprising the steps of:
(a) preparing a plurality of time slots by multi-dividing the synchronous part in one cycle; and
(b) allocating at least one divided time slot to each network end-point communicating in a corresponding cycle.

4. The time allocation method as claimed in claim 3, wherein, in step (b), the synchronous part is divided by the number of the ports of the gateway.

5. The time allocation method as claimed in claim 3, wherein, in step (b), only one divided time slot is allocated to each network end-point.

6. The time allocation method as claimed in claim 3, wherein, in step (b), the divided time slots are uniformly allocated to the network end-points communicating in a corresponding cycle.

7. The time allocation method as claimed in claim 3, wherein, in step (b), the divided time slots are allocated to each of network end-points communicating in a corresponding cycle in proportion to the number of destinations corresponding to each network end-point.
